(19) United States
(12) Patent Application Publication
(10) Pub. No.: US 2016/0166937 A1
(43) Pub. Date: Jun. 16, 2016

(54) SYSTEM AND METHOD FOR PROCESSING INFORMATION

(71) Applicant: SONY CORPORATION, Tokyo (JP)

(72) Inventor: SRIRAM SAMPATHKUMARAN, SAN DIEGO, CA (US)

(21) Appl. No.: 14/565,652

(22) Filed: Dec. 10, 2014

(51) Int. Cl. A63F 13/79

(52) U.S. Cl. CPC A63F 13/79

(57) ABSTRACT

Various aspects of a system and method to process information related to one or more players are disclosed herein. In accordance with an embodiment, the method includes receipt of device metadata and player information from one or more electronic devices in a communication network. The one or more electronic devices are associated with one or more players. One or more player profiles of the one or more players may be generated based on the received device metadata and the received player information.

### FIELD

Various embodiments of the disclosure relate to processing information. More specifically, various embodiments of the disclosure relate to processing information in an eco-system of various electronic devices.

### BACKGROUND

Advances in micro-machinery and digital technology have made it possible to develop and/or customize various electronic devices and applications for use in sports events. Various electronic devices, such as sensors, radars, and/or cameras, may provide huge amount of information related to a player's game in a sports event. However, some vital information about the player, various other players, different teams, and/or interesting moments in the sports event may be lost or ignored due to a lack of adequate technological eco-system and/or infrastructure.

In certain scenarios, it may be difficult to create a proper technological eco-system and/or a platform for such electronic devices to capture adequate information related to the player, various other players, and/or different teams. Further, it may be difficult to intelligently process such huge amount of information to provide vital insights for performance enhancement of the players and/or the different teams.

Further limitations and disadvantages of conventional and traditional approaches will become apparent to one of skill in the art, through comparison of described systems with some aspects of the present disclosure, as set forth in the remainder of the present application and with reference to the drawings.

### SUMMARY

A system and a method to process information substantially as shown in, and/or described in connection with, at least one of the figures, as set forth more completely in the claims.

These and other features and advantages of the present disclosure may be appreciated from a review of the following detailed description of the present disclosure, along with the accompanying figures in which like reference numerals refer to like parts throughout.

### BRIEF DESCRIPTION OF THE DRAWINGS

FIG. 1A is a block diagram that illustrates a network environment to process information, in accordance with an embodiment of the disclosure.

FIG. 1B is a block diagram that illustrates another network environment to process information, in accordance with another embodiment of the disclosure.

FIG. 2 is a block diagram that illustrates an exemplary server, in accordance with an embodiment of the disclosure.

FIGS. 3A, 3B, 3C, 3D, 3E, 3F, and 3G illustrate various aspects of a first exemplary scenario for implementation of the disclosed system and method to process information, in accordance with an embodiment of the disclosure.

FIG. 4 illustrates a second exemplary scenario for implementation of the disclosed system and method to process information, in accordance with an embodiment of the disclosure.

FIGS. 5A and 5B collectively represent a flow chart that illustrates an exemplary method to process information, in accordance with an embodiment of the disclosure.

### DETAILED DESCRIPTION

The following described implementations may be found in disclosed systems and methods that process information. Exemplary aspects of the disclosure may comprise a method that may receive device metadata and player information from one or more electronic devices in a communication network. The one or more electronic devices may be associated with one or more players. One or more player profiles of the one or more players may be generated based on the received device metadata and the received information.

In accordance with an embodiment, the device metadata may comprise device identifiers of the one or more electronic devices, user-type data, device category data, and/or configuration data associated with each of the one or more electronic devices. The user-type data may correspond to a player, a spectator, a referee, and/or a coach. The device category data may correspond to a data provider and/or a controller.

In accordance with an embodiment, the player information may correspond to stroke trajectory information of one or more items of sports equipment and shot-type information of the one or more items of sports equipment. The player information may further correspond to contact information of a moving object with the one or more items of sports equipment, speed information of the moving object, trajectory information of the moving object, and/or spin information of the moving object. The player information may further correspond to footwork information of the one or more players, heart rate monitoring information of the one or more players, a video feed associated with the one or more players, feedback information associated with the one or more players, geospatial positioning information of the one or more players, and/or one or more notifications that indicate a new session of a sports event with respect to the receipt of the player information.

In accordance with an embodiment, the one or more items of sports equipment may comprise a racquet, a bat, and/or a stick. The moving object may comprise a ball, shuttlecock, and/or a hockey puck. The moving object may be associated with the one or more items of sports equipment. The one or more electronic devices may comprise a sensor, a portable device, a radar, and/or a video capturing device.

In accordance with an embodiment, one of the one or more electronic devices may be operable to create an ad-hoc network to establish communication with others of the one or more electronic devices. The one of the one or more electronic devices may be communicatively coupled to one or more processors of the system in the communication network.

In accordance with an embodiment, a selective communication may be established among the one or more electronic devices within the communication network based on the received device metadata. In accordance with an embodiment, the generated one or more player profiles may be dynamically updated based on ongoing activity of one or more players in a sports event.

In accordance with an embodiment, the player information related to a shot played by a player may be categorized. Such categorization may occur based on analysis of the received player information and the received device metadata. The received player information may be associated with a time period that includes a timestamp when the moving object is in contact with an item of sports equipment. The item of sports equipment may be held by the player.

In accordance with an embodiment, a player profile from the generated one or more player profiles may be compared with other player profiles from the generated one or more player profiles. The player profile of a player may be compared with a historical player profile of the player.

In accordance with an embodiment, the method may comprise prediction of a movement of one or more items of sports equipment, the moving object, and/or the one or more players. The movement may correspond to a stroke trajectory of the item of sports equipment, a trajectory of the moving object, and/or footwork of the one or more players.

In accordance with an embodiment, the one or more electronic devices may be dynamically activated to perform corresponding action. Such dynamic activation may be based on a notification received from one of the one or more electronic devices and/or occurrence of an event. In accordance with an embodiment, one of the one or more electronic devices may be operable to dynamically activate others of the one or more electronic devices to perform corresponding action. The activation may be based on a notification received from one of the one or more electronic devices and/or occurrence of an event.

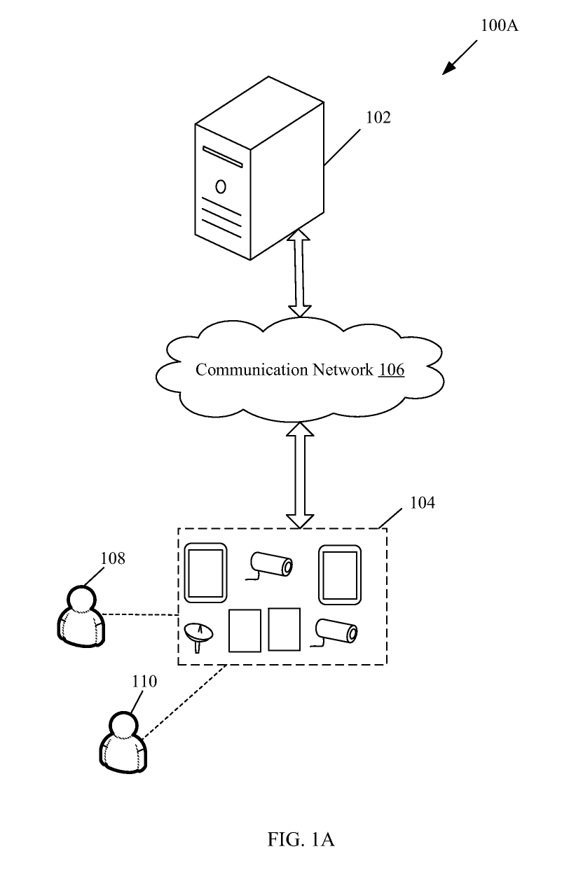

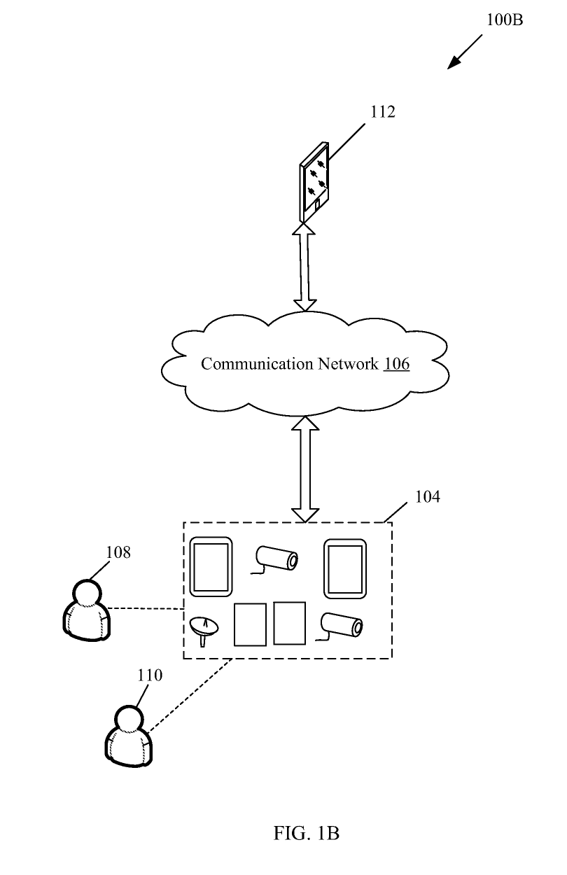

FIG. 1A is a block diagram that illustrates a network environment 100A to process information, in accordance with an embodiment of the disclosure. With reference to FIG. 1A, there is shown a server 102, one or more electronic devices 104, a communication network 106, and one or more sports players, such as a first player 108 and a second player 110. The server 102 may be communicatively coupled to the one or more electronic devices 104, via the communication network 106. The one or more electronic devices 104 may be associated with the first player 108 and the second player 110.

The server 102 may comprise suitable logic, circuitry, interfaces, and/or code that may be operable to receive requests from one or more subscribed devices, such as the one or more electronic devices 104. The server 102 may be further operable to process player information related to the one or more items of sports players. The server 102 may be implemented by use of several technologies that are well known to those skilled in the art. The server 102 may be implemented as a cloud server. Examples of the server 102 may include, but are not limited to, Apache^{Tm} HTTP Server, Microsoft® Internet Information Services (IIS), IBM® Application Server, and/or Sun Java™ System Web Server.

The one or more electronic devices 104 may comprise suitable logic, circuitry, interfaces, and/or code that may be operable to communicate player information of the one or more players, such as the first player 108 and the second player 110, to the server 102. The one or more electronic devices 104 may comprise one or more sensors, portable devices, radars, video-capturing devices, and/or the like.

The one or more sensors may detect events and physical or quantitative attributes and provide corresponding output. Physical or quantitative attributes may include pressure, motion, tension, and/or contact. Examples of the one or more sensors may include, but are not limited to, a pressure mat for detection of pressure exerted by a player on a hand grip of an item of sports equipment, such as a tennis racquet, a sensor for measurement of tension in string(s) of the sports equipment, such as a badminton racquet, and a sensor for detection of contact of a moving object, such as a ball, with an item of sports equipment, such as a bat. The one or more sensors may further include a stroke trajectory sensor, a sensor for detection of displacement trajectory of the moving object, a sensor for detection of speed and/or spin of the moving object, a geospatial positioning detection sensor, a sensor for detection of footwork of a player, a heart-rate monitoring sensor, a sensor for detection of physiological parameters of a player, such as respiratory rate or body temperature, an image sensor for image-based plethysmography. Examples of the items of sports equipment held by a player may include, but are not limited to, a tennis racquet, a squash racquet, a racquetball racquet, a badminton racquet, a cricket bat, a baseball bat, a hockey stick, a lacrosse stick, and/or other racquets, sticks or bats. Examples of the moving object hit by the player with the sports equipment may include, but are not limited to, a ball, a shuttlecock, and/or a hockey puck.

The one or more portable devices may be operable to receive input and display output, via a user interface (UI), to the one or more players, such as the first player 108 and the second player 110. Examples of one or more portable devices may include, but are not limited to, a smartphone, a tablet computer, a laptop, a Personal Digital Assistant (PDA) device, and/or a wearable electronic device such as a smartwatch. The one or more portable devices may comprise one or more display screens (not shown). The display screen may comprise suitable logic, circuitry, interfaces, and/or code that may be operable to display the UI. The display screen may be further operable to render one or more features and/or applications of the portable device. The display screen may be realized through several known technologies such as but not limited to, Liquid Crystal Display (LCD) display, Light Emitting Diode (LED) display, and/or Organic Light Emitting Diode (OLED) display technology.

The one or more radars may detect range, altitude, direction, or speed of objects, such as the speed of a ball. Examples of the one or more radars may include, but are not limited to, a radio waves-based object-detection system and/or laser light-based object-detection system.

The one or more video-capturing devices may be operable to capture photographs, video and/or audio of the first player 108 and the second player 110 in a sports event. The one or more video-capturing devices may be placed at strategic locations in the sports event, such as a net area and/or a baseline area of a tennis court. The one or more video-capturing devices may be operable to detect an incoming and/or outgoing moving object, such as a ball that approaches towards the one or more players. Examples of the video-capturing device may include, but are not limited to, a video camera, a photograph-capturing device, and/or an action camera.

The communication network 106 may include a medium through which one or more servers, such as the server 102, may communicate with the one or more electronic devices 104. Examples of the communication network 106 may include, but are not limited to, the Internet, a cloud network, a Wireless Fidelity (Wi-Fi) network, a Wireless Local Area Network (WLAN), a Local Area Network (LAN), a plain old telephone service (POTS), a Metropolitan Area Network (MAN), and/or a short-range communication medium. Various devices in the network environment 100 may be operable to connect to the communication network 106, in accordance with various wired and wireless communication protocols. Examples of such wired and wireless communication protocols may include, but are not limited to, Transmission Control Protocol and Internet Protocol (TCP/IP), User Datagram Protocol (UDP), Hypertext Transfer Protocol (HTTP), File Transfer Protocol (FTP), ZigBee, infrared (IR), IEEE 802.11, 802.16, cellular communication protocols, and/or Bluetooth (BT) communication protocols.

In operation, the one or more electronic devices 104 may be operable to communicate device metadata to the server 102. The server 102 may be operable to receive device metadata from the one or more electronic devices 104, via the communication network 106. In accordance with an embodiment, the server 102 may be operable to establish selective communication among the one or more electronic devices 104 in the communication network 106. Such selective communication may be established based on the received device metadata. In accordance with an embodiment, one of the one or more electronic devices 104 may be operable to create an ad-hoc network, such as a Wi-Fi network, to establish selective communication with others of the one or more electronic devices 104.

The one or more electronic devices 104 associated with the one or more players may be operable to communicate player information related to the one or more players to the server 102. The server 102 may be operable to receive player information related to the one or more players from the one or more electronic devices 104, via the communication network 106. The received player information may comprise information associated with one or more actions performed by the one or more players and corresponding time periods during the game play. The time periods may further include one or more timestamps when the one or more actions are performed. For example, in tennis, the one or more actions may correspond to one or more shots that may be categorized based on when the ball is hit (such as a serve, a groundstroke, a volley, and/or a half volley) or how the ball is hit (a smash, a forehand, a backhand, a slice, and/or a topspin shot), or where the ball is hit (a lob, a passing shot, a dropshot, a cross-court shot, and/or a down-the-line shot).

The server 102 may be operable to categorize the received player information related to a shot played by a player, such as the first player 108. Such categorization may be based on analysis of the received player information and the received device metadata.

The server 102 may be operable to generate one or more player profiles of the one or more players, based on the received device metadata and the received player information. The server 102 may be operable to dynamically update the generated one or more player profiles, based on ongoing activity of the one or more players in the sports event. The server 102 may be further operable to compare the generated player profile of the first player 108 with another player profile of the second player 110. The server 102 may be operable to compare the generated player profile of the first player 108 with a historical player profile of the first player 108. The server 102 may be operable to generate a profile for the sports event based on the received player information from the one or more electronic devices 104, associated with the first player 108 and the second player 110.

In accordance with an embodiment, the server 102 may be operable to predict a movement of the one or more items of sports equipment, the moving object, and/or the one or more players. The movement may correspond to a stroke trajectory of the item of sports equipment, such as a racquet, a trajectory of the moving object, such as a tennis ball, and/or footwork of the one or more players during the game play. In accordance with an embodiment, the server 102 may be operable to dynamically activate the one or more electronic devices 104. The one or more electronic devices 104 may be dynamically activated to perform corresponding action based on a notification received from one of the one or more electronic devices 104 and/or occurrence of an event.

In accordance with an embodiment, the server 102 may be operable to generate recommendations related to performance of the one or more players, such as the first player 108 and the second player 110. Such recommendations may be based on the profile comparisons and/or the movement predictions, as described above.

In accordance with an embodiment, the one of the one or more electronic devices 104 may be operable to dynamically activate others of the one or more electronic devices 104 to perform corresponding action. For example, the one or more video capturing devices may capture photographs or the one or more sensors may start or stop detection of an event, physical or quantitative attributes, when dynamically activated. Such activation may occur based on a notification received from one of the one or more electronic devices 104, and/or occurrence of an event.

FIG. 1B is a block diagram that illustrates another network environment 100B to process information, in accordance with another embodiment of the disclosure. FIG. 1B is explained in conjunction with elements from FIG. 1A. With reference to FIG. 1B, there is shown the one or more electronic devices 104, the communication network 106, the one or more sports players, such as the first player 108 and the second player 110, and a mobile device 112. The mobile device 112 may be communicatively coupled to the one or more electronic devices 104, via the communication network 106. In addition to the one or more electronic devices 104, the mobile device 112 may also be associated with one of the one or more sports players, such as the first player 108.

The mobile device 112 may comprise suitable logic, circuitry, interfaces, and/or code that may be operable to receive and/or process player information of the one or more players, such as the first player 108. Examples of the mobile device 112 may include, but are not limited to, a smartphone, a tablet computer, a laptop, a Personal Digital Assistant (PDA) device, and/or other mobile computing device.

In operation, the mobile device 112 may be operable to receive device metadata from the one or more electronic devices 104, via the communication network 106. In accordance with an embodiment, the mobile device 112 may create an ad-hoc network, such as a Wi-Fi network, to establish communication with the one or more electronic devices 104. In such an embodiment, the mobile device 112 may be operable to receive device metadata from the one or more electronic devices 104, via the created ad-hoc network and/or the communication network 106.

The mobile device 112 may be operable to establish selective communication among the one or more electronic devices 104 in the communication network 106. Such selective communication may be established based on the received device metadata.

The mobile device 112 may be operable to receive player information related to the one or more players from the one or more electronic devices 104, via the created ad-hoc network and/or the communication network 106.

The mobile device 112 may be operable to categorize the received player information related to a shot played by a player, such as the first player 108. Such categorization may be based on analysis of the received player information and the received device metadata.

In accordance with an embodiment, the mobile device 112 may be operable to generate one or more player profiles of the one or more players, based on the received device metadata and the received player information. The mobile device 112 may be operable to dynamically update the generated one or more player profiles, based on ongoing activity of the one or more players in the sports event.

The mobile device 112 may be further operable to compare the generated player profile of the first player 108 with another player profile of the second player 110. The mobile device 112 may be operable to compare the generated player profile of the first player 108 with a historical player profile of the first player 108. The mobile device 112 may be operable to generate a profile for the sports event based on the received player information from the one or more electronic devices 104, associated with the first player 108 and the second player 110.

In accordance with an embodiment, the mobile device 112 may be operable to predict a movement of the one or more items of sports equipment, the moving object, and/or the one or more players. The movement may correspond to a stroke trajectory of the item of sports equipment, such as a racquet, a trajectory of the moving object, such as a tennis ball, and/or footwork of the one or more players during the game play.

In accordance with an embodiment, the mobile device 112 may be operable to generate recommendations related to performance of the one or more players. Such recommendations may be based on the profile comparisons and/or the movement predictions, as described above.

In accordance with an embodiment, the mobile device 112 may be operable to dynamically activate the one or more electronic devices 104. The one or more electronic devices 104 may be dynamically activated to perform corresponding action based on a notification communicated from the mobile device 112 and/or occurrence of an event.

In accordance with an embodiment, the received device metadata and the received player information may be communicated to the server 102 for further processing. For example, the categorization of the received player information, the profile generation, the profile comparison, the prediction of the movement of the one or more items of sports equipment, the moving object, and/or the one or more players, may occur at the server 102. In an exemplary scenario, another mobile device similar to the mobile device 112 may be associated with another player, such as the second player 110. In such a scenario, the processing performed by the mobile device 112 for the first player 108 may be performed by the other mobile device for the second player 110 in the similar manner as of the mobile device 112.

In accordance with an embodiment, the functionalities of the server 102 may be partly or completely implemented in other devices, such as the mobile device 112, other portable devices of the one or more electronic device 104, and/or other servers, such as a cloud server, without deviating from the scope of the disclosure.

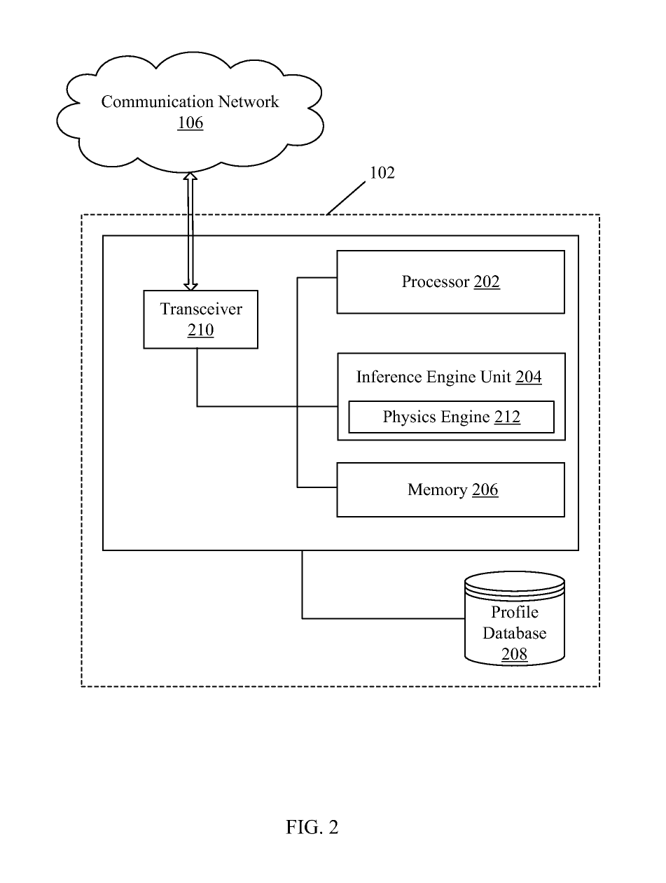

FIG. 2 is a block diagram that illustrates an exemplary server, in accordance with an embodiment of the disclosure. FIG. 2 is explained in conjunction with elements from FIG. 1A. With reference to FIG. 2, there is shown the server 102. The server 102 may comprise one or more processors, such as a processor 202, an inference engine unit 204, a memory 206, a profile database 208, and a transceiver 210. The inference engine unit 204 may include a physics engine 212.

The processor 202 may be communicatively coupled to the inference engine unit 204, the memory 206, the profile database 208, the transceiver 210, and the physics engine 212. The transceiver 210 may be operable to communicate with the one or more electronic devices 104, via the communication network 106.

The processor 202 may comprise suitable logic, circuitry, interfaces, and/or code that may be operable to execute a set of instructions stored in the memory 206. The processor 202 may be implemented based on a number of processor technologies known in the art. Examples of the processor 202 may be an X86-based processor, a Reduced Instruction Set Computing (RISC) processor, an Application-Specific Integrated Circuit (ASIC) processor, a Complex Instruction Set Computing (CISC) processor, and/or other processors.

The inference engine unit 204 may comprise suitable logic, circuitry, interfaces, and/or code that may be operable to analyze the player information received from the one or more electronic devices 104. Based on the analysis, the inference engine unit 204 may be operable to categorize information related to one or more shots played by the one or more players. Examples of the inference engine unit 204 may be an X86-based processor, a Reduced Instruction Set Computing (RISC) processor, an Application-Specific Integrated Circuit (ASIC) processor, a Complex Instruction Set Computing (CISC) processor, and/or other processors. In accordance with an embodiment, the inference engine unit 204 may be a part of the processor 202. In accordance with an embodiment, both the inference engine unit 204 and the processor 202 may be implemented as a cluster of processors or an integrated processor. Such a cluster of processors or integrated processors may perform the functions of both the inference engine unit 204 and the processor 202.

The inference engine unit 204 may be implemented based on one or more approaches, such as an artificial neural network (ANN), an inductive logic programming approach, a support vector machine (SVM), an association rule learning approach, a decision tree learning approach, and/or a Bayesian network. Notwithstanding, the disclosure may not be so limited and other suitable learning approaches may be utilized without limiting the scope of the disclosure.

The memory 206 may comprise suitable logic, circuitry, and/or interfaces that may be operable to store a machine code and/or a computer program with at least one code section executable by the processor 202. The memory 206 may further be operable to store operating systems, and associated applications. Examples of implementation of the memory 206 may include, but are not limited to, Random Access Memory (RAM), Read Only Memory (ROM), Hard Disk Drive (HDD), Flash memory, and/or a Secure Digital (SD) card.

The profile database 208 may comprise suitable logic, circuitry, and/or interfaces that may be operable to store one or more player profiles, such as player profiles of the first player 108 and the second player 110. The profile database 208 may be further operable to store learned data. Such learned data may be generated by the inference engine unit 204, based on the analysis of the player information received from the one or more electronic devices 104.

The transceiver 210 may comprise suitable logic, circuitry, interfaces, and/or code that may be operable to communicate with one or more electronic devices 104. The transceiver 210 may include, but is not limited to, an antenna, a radio frequency (RF) transceiver, one or more amplifiers, a tuner, one or more oscillators, a digital signal processor, a coder-decoder (CODEC) chipset, a subscriber identity module (SIM) card, and/or a local buffer.

The transceiver 210 may communicate via wireless communication with networks, such as the communication network 106. The wireless communication may use any of a plurality of communication standards, protocols and technologies, such as Global System for Mobile Communications (GSM), Enhanced Data GSM Environment (EDGE), wideband code division multiple access (W-CDMA), code division multiple access (CDMA), time division multiple access (TDMA), Bluetooth, Wireless Fidelity (Wi-Fi) (such as IEEE 802.11a, IEEE 802.11b, IEEE 802.11g and/or IEEE 802.11n), voice over Internet Protocol (VoIP), Wi-MAX, NFC protocol, a protocol for email, instant messaging, and/or Short Message Service (SMS).

The physics engine 212 may comprise suitable logic, circuitry, interfaces, and/or code that may be operable to predict a movement of one or more items of sports equipment, such as the stroke trajectory of a racquet. The physics engine 212 may further predict the movement of the moving object, such as the displacement trajectory of a ball. The physics engine 212 may further predict movement of the one or more players, such as the footwork of the first player 108 and the second player 110. In accordance with an embodiment, the physics engine 212 may be implemented as a part of the processor 202.

In operation, the transceiver 210 may be operable to receive device metadata and player information from the one or more electronic devices 104, via the communication network 106. The transceiver 210 may be further operable to communicate the received device metadata to the processor 202. The device metadata may comprise device identifiers of the one or more electronic devices 104, user-type data, device category data, and/or configuration data associated with each of the one or more electronic devices 104. The user-type data may correspond to a player, a spectator, a referee, and/or a coach, associated with the one or more electronic devices 104. The device category data may aid in classification of the one or more electronic devices 104 into data providers and/or one or more controllers.

In accordance with an embodiment, the processor 202 may be operable to establish a selective communication among the one or more electronic devices 104, in the communication network 106. Such selective communication may be established based on the received device metadata. Based on the established selective communication, the processor 202 may be operable to create a restricted sub-network within the communication network 106. For example, a first set of the one or more electronic devices 104, associated with the first player 108, may communicate with each other in a restricted sub-network. Similarly, a second set of the one or more electronic devices 104, associated with the second player 110, may communicate with each other in another restricted sub-network. The first set of electronic devices in the restricted sub-network may not communicate or share information with the second set of the electronic devices in the other restricted sub-network.

The processor 202 may be operable to receive player information related to the one or more players from the one or more electronic devices 104. The player information may correspond to stroke trajectory information of the one or more items of sports equipment held by the one or more players, such as the first player 108 and the second player 110. The player information may correspond to shot-type information of the one or more items of sports equipment, such as a backhand, a forehand, a smash, a top-spin, and/or a slice shot. The player information may further correspond to speed information, stroke trajectory information, displacement trajectory information, and/or spin information of the moving object. The player information may further correspond to footwork information, heart-rate monitoring information, geospatial positioning information, and/or a video feed associated with the one or more players, such as the first player 108 and the second player 110.

The player information may further correspond to one or more notifications that may indicate a new session of the sports event. For example, the first player 108 may provide one or more input commands via a UI of a first portable device. The one or more input commands may correspond to start, stop or pause commands for transmission of the player information related to the first player 108 during a current session of the sports event. The one or more input commands may be communicated to the server 102 by the first portable device or other of the one or more electronic devices 104 to indicate a new session. The first portable device may be one of the one or more electronic devices 104.

The player information may further correspond to additional information, such as instructions and/or scores, associated with the one or more players. For example, one of the one or more electronic devices 104, such as a second portable device, may be associated with a coach in the sports event. Similarly, a third portable device may be associated with a referee in the sports event. The coach may be a personal instructor for a player, such as a first player 108, in a sports event. The coach may provide the instructions during a current session of the sports event, via a UI of the second portable device. Similarly, a referee may feed scores and/or provide instructions for the one or more players, via a UI of the third portable device.

The player information may further correspond to feedback information associated with the one or more players. For example, one of the one or more electronic devices 104, such as a fourth portable device, may be associated with a spectator. The spectator of the sports event may feed the feedback information related to the performance of the one or more players, via a UI of the fourth portable device. Each of the UIs of the first portable device, the second portable device, the third portable device, and the fourth portable device may correspond to one or more applications. The one or more applications may be pre-installed at the one or more portable devices, such as the first portable device, the second portable device, the third portable device, and the fourth portable device.

The processor 202 may be operable to analyze the received player information by use of the inference engine unit 204. The processor 202 may be operable to categorize one or more shots of the one or more players based on the analysis of the received player information. For example, the processor 202 may be operable to categorize the player information related to a shot of the first player 108, based on analysis of the received player information and the received device metadata. The received player information may be associated with a time period. The time period may include a timestamp when the moving object, such as a ball, is in contact with the item of sports equipment, such as the racquet. The item of sports equipment may be held by the first player 108. Similarly, the processor 202 may be operable to determine information about one or more shots of the second player 110, based on the analysis of the received player information and the received device metadata.

The processor 202 may be operable to generate a player profile of the first player 108, based on the received device metadata and the received player information. Similarly, the processor 202 may be operable to generate a player profile of a second player 110, based on the received device metadata and the received player information. The processor 202 may be operable to dynamically update the generated player profile of the first player 108. The generated player profile may be dynamically updated based on ongoing activity of the first player 108 in the sports event, such as a tennis game. The processor 202 may be operable to compare the generated player profile of the first player 108 with the generated player profile of the second player 110.

The processor 202 may be operable to compare the generated player profile of the first player 108 with a historical player profile of the first player 108. The processor 202 may be operable to generate a sports event profile for the sports event, such as the tennis game. Such generation of the sports event profile may occur based on the received player information from the one or more electronic devices 104, associated with the first player 108 and the second player 110.

In accordance with an embodiment, the processor 202 may be operable to predict a movement of the one or more items of the sports equipment, the moving object, and/or the one or more players. Such prediction may occur by use of the physics engine 212. The movement may correspond to a stroke trajectory of the item of sports equipment, displacement trajectory of the moving object, and/or footwork of the one or more players.

In accordance with an embodiment, the processor 202 may be operable to dynamically activate the one or more electronic devices 104 to perform corresponding action. For example, the one or more video capturing devices may be triggered to capture a photograph, or the one or more sensors may be triggered to start or stop detection of an event, physical or quantitative attributes. Such activation may occur based on a notification received from one of the one or more electronic devices 104 and/or occurrence of an event. For example, the video-capturing device may detect a ball heading towards the first player 108. Subsequently, the video-capturing device may communicate or broadcast a notification to another of the one or more electronic devices 104, such as the one or more sensors. In response to the notification, the one or more electronic devices 104 may be triggered to resume detection or recording of the player information. For example, the racquet sensor may be activated to detect contact of a ball with the racquet. Such dynamic activation of the one or more electronic devices 104 may enable capture of adequate and useful information in a synchronized manner. The dynamic activation may also save power and optimize network bandwidth usage.

In accordance with an embodiment, the inference engine unit 204 and/or the physics engine 212 may be implemented in the mobile device 112. In accordance with an embodiment, the functionalities performed by the processor 202 may also be performed by the mobile device 112, or the one or more portable devices, such as the first portable device. It shall be appreciated that although various embodiments are described taking example of the server 102, similar processing may be performed by the mobile device 112, without deviating from the scope of the disclosure.

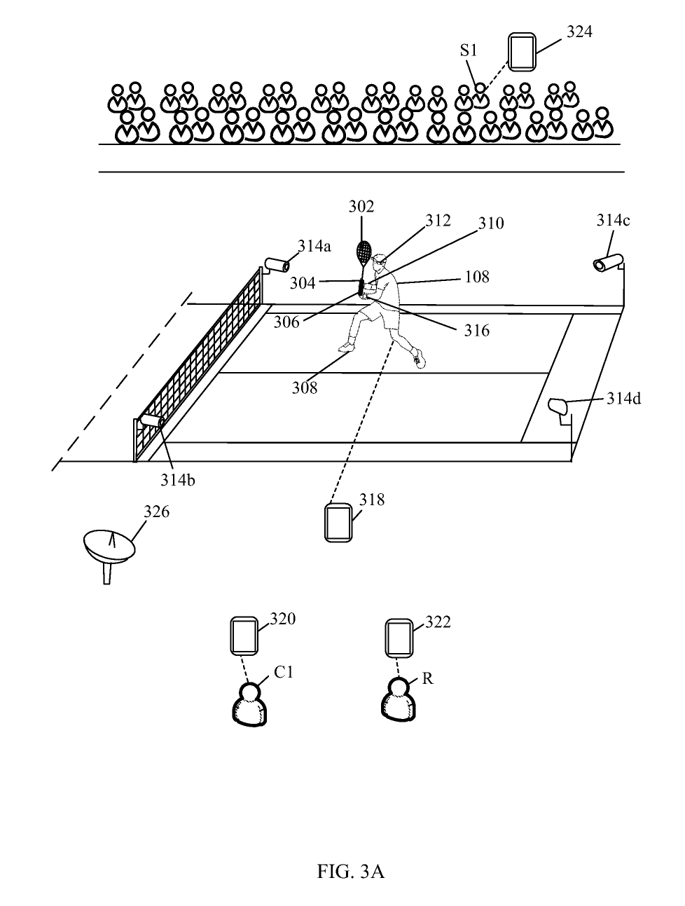

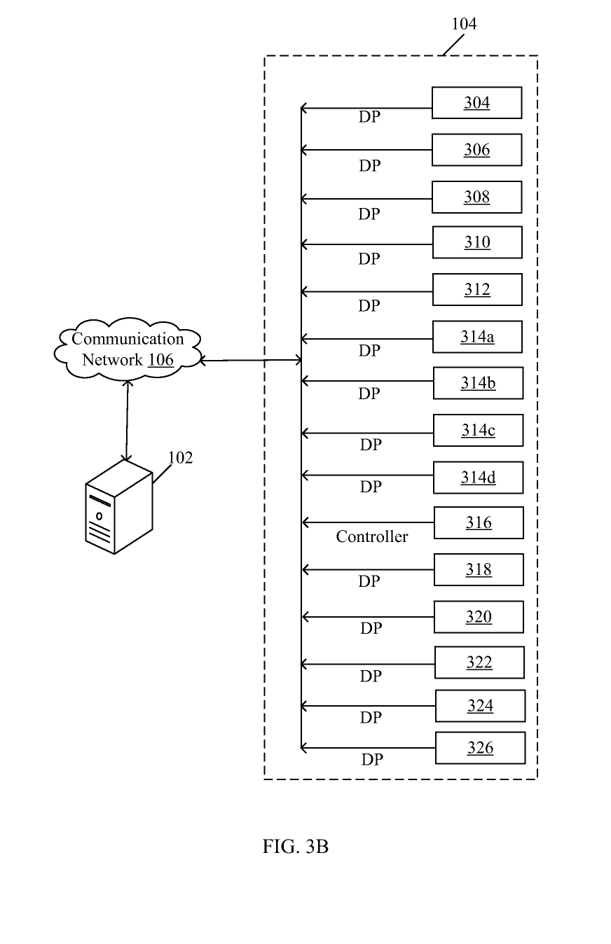

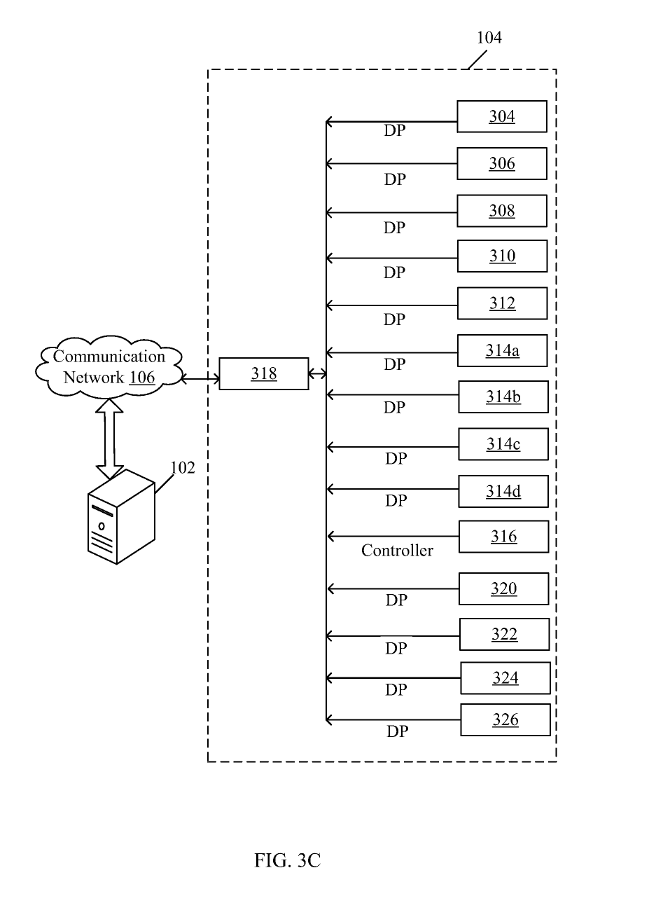

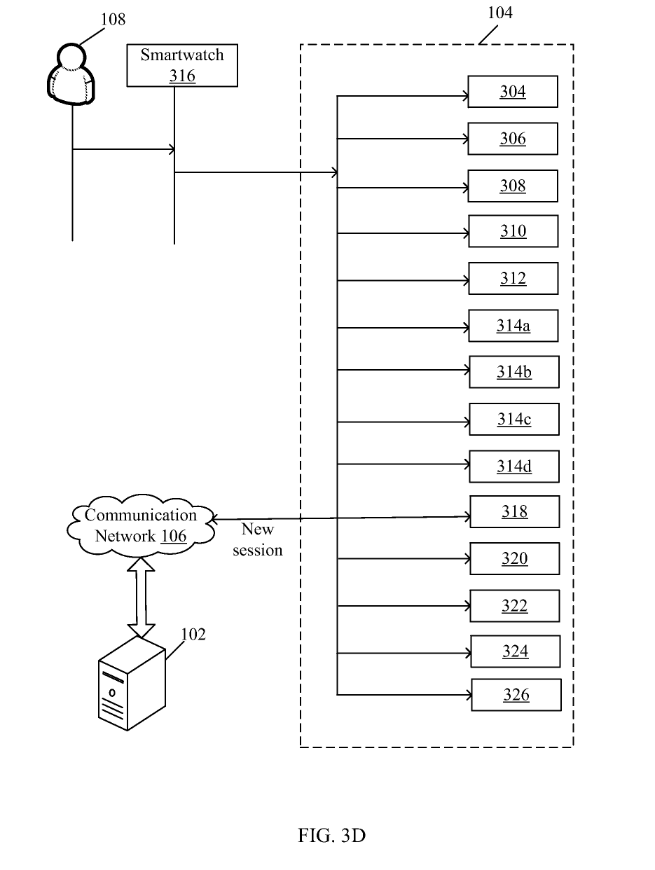

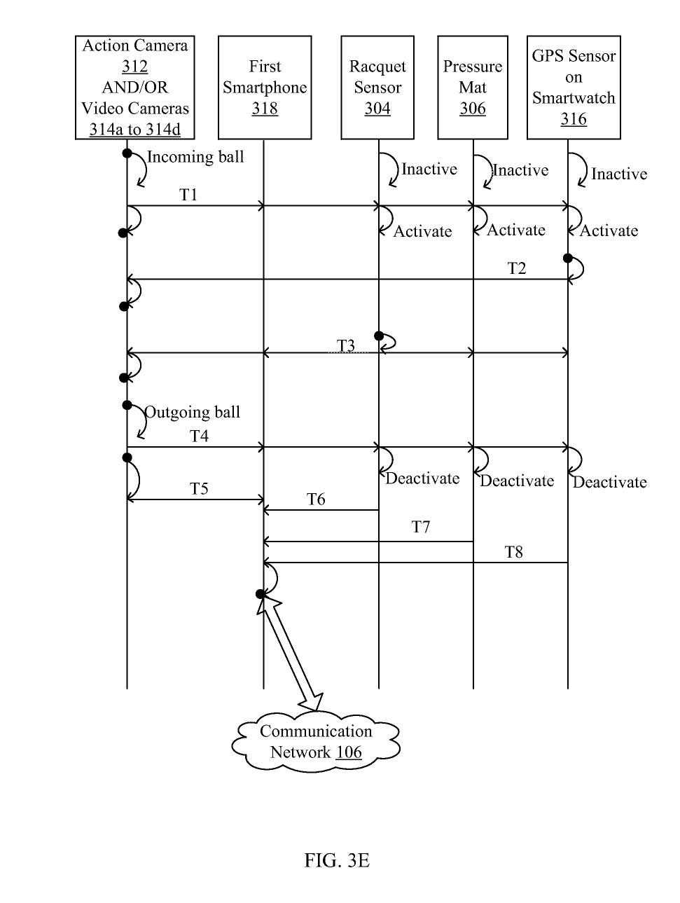

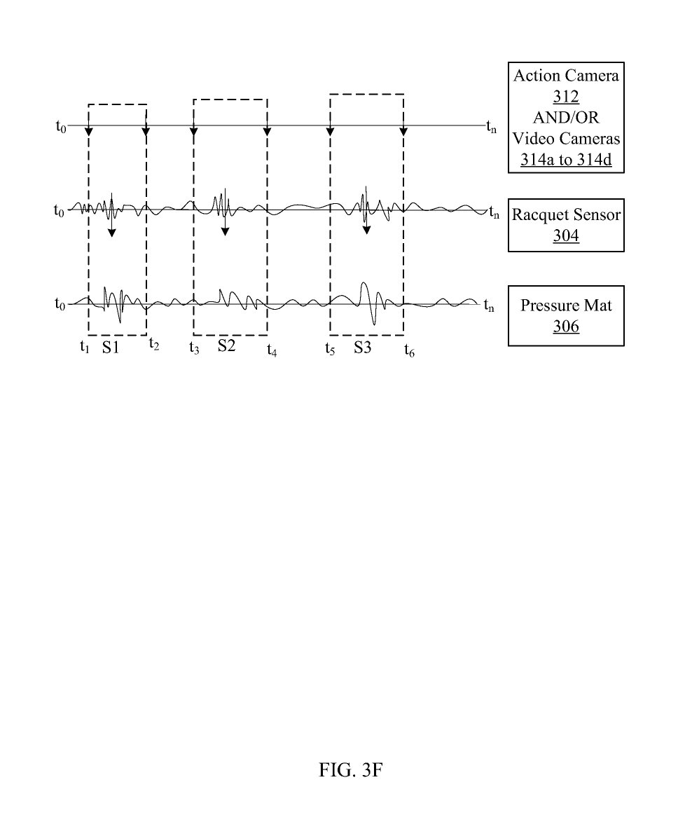

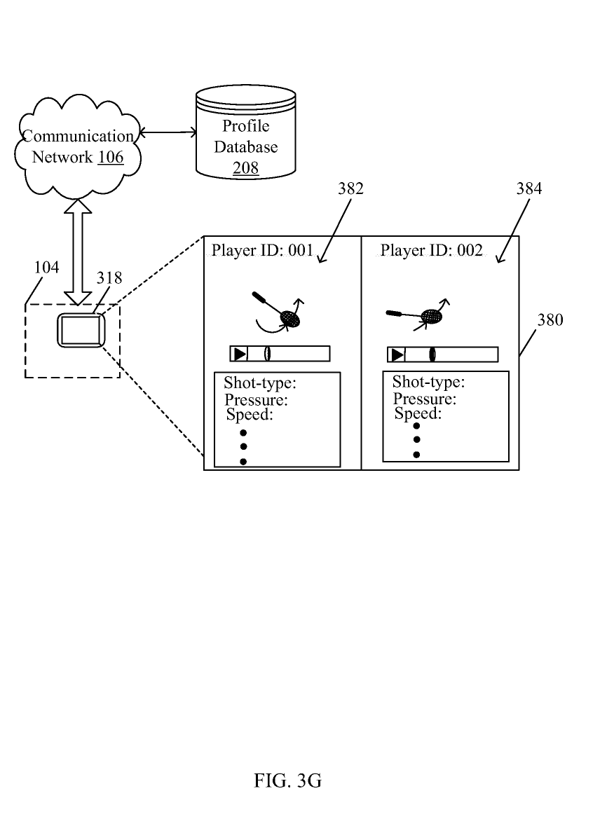

FIGS. 3A, 3B, 3C, 3D, 3E, 3F and 3G illustrate various aspects of a first exemplary scenario for the implementation of the disclosed system and method to process information, in accordance with an embodiment of the disclosure. FIGS. 3A, 3B, 3C, 3D, 3E, 3F and 3G are explained in conjunction with elements from FIG. 1A and FIG. 2. With reference to FIG. 3A, there is shown an item of sports equipment, such as a racquet 302, which may be held by the first player 108. There is further shown a racquet sensor 304, a pressure mat 306, a footwork sensor 308, a heart-rate monitoring sensor 310, an action camera 312, video cameras 314a and 314b located near a net area of a tennis court, video cameras 314c and 314d located near a baseline area of the tennis court, a smartwatch 316, a first smartphone 318 associated with the first player 108, a second smartphone 320 associated with a coach, “C1”, of the first player 108, a third smartphone 322 associated with a referee, “R”, of a tennis sports event, and a fourth smartphone 324 associated with a spectator, “S1”, of the tennis sports event, and a ball radar 326.

In accordance with the first exemplary scenario, the racquet sensor 304, the pressure mat 306, the footwork sensor 308, and/or the heart-rate monitoring sensor 310, may correspond to the one or more sensors of the one or more electronic devices 104. The action camera 312 and the video cameras 314a to 314d may correspond to the one or more video-capturing devices from the one or more electronic devices 104. The smartwatch 316, the first smartphone 318, the second smartphone 320, the third smartphone 322, and the fourth smartphone 324 may correspond to the one or more portable devices from the one or more electronic devices 104. The ball radar 326 may correspond to the one or more radars from the one or more electronic devices 104.

In operation, a player, such as the first player 108, may provide an input on a UI (not shown) of the first smartphone 318 to create an ad-hoc communication network, such as a Wi-Fi hotspot, to establish selective communication with others of the one or more electronic devices 104.

With reference to FIG. 3B, there is shown communication of device metadata from the one or more electronic devices 104 to the server 102 in the ad-hoc communication network, in accordance with an embodiment.

The processor 202 may be operable to receive device metadata from the one or more electronic devices 104, via the communication network, such as an ad-hoc communication network. The device metadata may comprise the unique ID of each of the one or more electronic devices 104, user-type data, device category data, and/or configuration data associated with each of the one or more electronic devices 104. For example, the first player 108 may pre-set a first user-type data, such as, “Player”, via the UI of the first smartphone 318. The coach, “C1”, may pre-set a second user-type data, such as, “Coach”, via a UI of the second smartphone 320. The referee “R”, may pre-set a third user-type data, such as, “Referee”, via a UI of the third smartphone 322. Similarly, one or more spectators, such as the spectator “S1”, may pre-set a fourth user-type data, such as, “Spectator”, via a UI of the fourth smartphone 324.

The device category data may correspond to a data provider and/or a controller. For example, a set of the one or more electronic devices 104 that are pre-set to the data provider category, such as, “DP”, may be operable to communicate player information related to the first player 108. Another set of the one or more electronic devices 104 that are pre-set to the controller category, such as, “Controller”, may be operable to activate or deactivate other one or more electronic devices 104.

With reference to FIG. 3C, there is shown communication of device metadata from the one or more electronic devices 104 to the server 102, via one of the one or more electronic devices 104, in accordance with an embodiment.

The device metadata may first be communicated to one of the one or more electronic devices 104, such as the first smartphone 318, via the Wi-Fi network. The first smartphone 318 may subsequently communicate the device metadata to the server 102, via the communication network 106 (as shown). The processor 202 may be operable to receive device metadata from the one or more electronic devices 104, such as the first smartphone 318, via the communication network 106.

With reference to FIG. 3D, there is shown the communication of device metadata, such as the one or more notifications, that may indicate a new session of the tennis sports event. In the above example, the smartwatch 316 may be operable to receive input, via a UI of the smartwatch 316. In response to the received input, the smartwatch 316 may be operable to communicate one or more notifications to others of the one or more electronic devices 104 (as shown).

One of the one or more electronic devices 104, such as the first smartphone 318, may subsequently communicate the one or more notifications to the server 102, via the communication network 106. Such notifications may indicate start, stop or pause of a current session of the sports event, such as tennis.

In accordance with an embodiment, the processor 202 may be operable to dynamically activate the one or more electronic devices 104 to perform corresponding action. Such activation may occur based on a notification received from one of the one or more electronic devices 104 and/or occurrence of an event. For example, based on the start notification received from the smartwatch 316, the processor 202 may be operable to activate the one or more electronic devices 104, such as the action camera 312 and/or the video cameras 314a to 314d.

In accordance with an embodiment, one of the one or more electronic devices 104, such as the action camera 312, may be operable to dynamically activate others of one or more electronic devices 104 to perform corresponding action, such as detection and/or recording of sensor data by the racquet sensor 304 and the pressure mat 306. Such activation may occur based on a notification received from one of the one or more electronic devices 104, such as the smartwatch 316. In accordance with an embodiment, such activation may occur based on the occurrence of an event, such as detection of a ball heading (incoming ball) towards the first player 108.

With reference to FIG. 3E, there is shown an exemplary timing diagram that illustrates dynamic activation of the one or more electronic devices 104, such as the action camera 312, the racquet sensor 304, the pressure mat 306, the smartwatch 316, and the video cameras 314a to 314d. The smartwatch 316 may include a global positioning system (GPS) sensor. The one or more electronic devices 104 may be in an inactive state. The inactive state may be employed to save power, avoid redundant measurement, and/or detection of events and/or physical or quantitative attributes (such as pressure, contact, and/or geospatial positioning information).

The action camera 312 and/or the video cameras 314a to 314d may be operable to detect a ball heading towards the first player 108. Such detection may occur in a live video feed that may be captured by the action camera 312 and/or the video cameras 314a to 314d.

At time “T1”, a notification may be communicated to the one or more electronic devices 104 related to the detection of the incoming ball. Such notification may be communicated by the action camera 312 or one of the video cameras 314a to 314d that may detect the incoming ball. In response to the notification, the one or more electronic devices 104 may be dynamically activated to perform corresponding action. For example, the racquet sensor 304 may be activated to detect contact of the ball with the racquet 302. The pressure mat 306 may be activated to detect pressure exerted by the first player 108 on a hand grip of the racquet 302. The GPS sensor of the smartwatch 316 may be activated to detect geospatial positioning information of the first player 108. The first smartphone 318 may be activated to receive player information. The action camera 312 and/or the video cameras 314a to 314d may detect trajectory of the moving object, such as the ball.

At time “T2”, the GPS sensor may be operable to communicate the detected current geospatial positioning information of the first player 108 to the one or more electronic devices 104. In response to the notification, the action camera 312 and/or the video cameras 314a to 314d may be operable to adjust view, such as pan or zoom view, with respect to location of the first player 108. For example, the video cameras 314a and 314b, located at the net area, may be triggered to adjust the view when the geospatial position of the first player 108 is detected near the net area.

At time “T3”, the racquet sensor 304 may be operable to communicate a notification of a hit ball to the one or more electronic devices 104. Such communication may occur when contact of the ball with the racquet 302 is detected. In response to the notification, the action camera 312 and/or the video cameras 314a to 314d may be operable to capture a photograph of a view of the first player 108. The view may coincide with the moment when the first player 108 hits the ball with the racquet 302. The smartwatch 316 may be operable to output a voice-response, such as “Good shot!”

At time “T4”, a notification may be communicated to the one or more electronic devices 104 related to the detection of the outgoing ball. Such notification may be communicated by the action camera 312, or one of the video cameras 314a to 314d, which may detect the outgoing ball. In response to the notification, the one or more electronic devices 104, such as the racquet sensor 304, the pressure mat 306, and/or the GPS sensor on the smartwatch 316, may be dynamically deactivated. In other words, the measurements or detection by the one or more sensors, such as the racquet sensor 304, the pressure mat 306, the GPS sensor on the smartwatch 316, may be paused.

At time “T5”, the action camera 312 and/or the video cameras 314a to 314d may communicate detected trajectory information of the ball, spin information of the ball, and/or captured video feed, photographs to the first smartphone 318. At time “T6”, the racquet sensor 304 may communicate, to the first smartphone 318, contact information of the moving object with the racquet 302 and stroke trajectory information of the racquet 302.

At time “T7”, the pressure mat 306 may communicate detected pressure information to the first smartphone 318. The detected pressure information may correspond to pressure exerted by the first player 108 on the hand grip of the racquet 302. At time “T8”, the GPS sensor on the smartwatch 316 may communicate feedback information, such as, “Good shot!”, and geospatial positioning information of the first player 108, to the first smartphone 318.

In accordance with an embodiment, the communication of the player information may occur simultaneously after the detection of the outgoing ball. The first smartphone 318 may be operable to communicate the received player information from the one or more electronic devices 104 to the server 102, via the communication network 106.

In accordance with an embodiment, the one or more electronic devices 104 may communicate the detected and/or captured information directly to the server 102. For example, the action camera 312 and/or the video cameras 314a to 314d may communicate the detected trajectory information of the ball, spin information of the ball, and/or captured video feed or photographs, to the server 102.

With respect to FIG. 3F, there is shown a schematic representation that illustrates categorization of the player information related to one or more shots, such as shots “S1” to “S3”, played by the first player 108. There is further shown the racquet sensor 304, the pressure mat 306, the action camera 312, and the video cameras 314a to 314d in the schematic representation.

In operation, the processor 202 may be operable to analyze the received player information by use of the inference engine unit 204. The processor 202 may be operable to categorize information related to the one or more shots, such as the shots, “S1” to “S3”, based on analysis of the received player information and the received device metadata. The received player information may be associated with one or more time periods, such as “t₁” to “t₂”, “t₃” to “t₄”, and “t₅” to “t₆”. The time period, such as “t₁” to “t₂”, may begin from the time when the incoming ball is detected to the time when the outgoing ball is detected. Such time period may include a timestamp when the ball is in contact with the racquet 302. In accordance with an embodiment, the time period, such as “t₁” to “t₂”, may also include time of movement of the racquet 302 related to the shot, “S1”.

The processor 202 may be operable to generate a player profile of the first player 108, based on the received device metadata and the received player information. It is to be appreciated that the received player information may also comprise information from other sensors and/or others of the one or more electronic devices 104. For example, score information associated with the first player 108 may be received from the third smartphone 322. The scores may be provided by the referee, “R”, via a UI of the third smartphone 322. The score information may also include timestamps. Such player profile may be generated by use of the inference engine unit 204.

With respect to FIG. 3G, there is shown a UI 380 on the display screen of the first smartphone 118, in accordance with an embodiment. The UI 380 may include a first portion 382 that may be adapted to display a first player profile, such as a player profile of the first player 108. The UI 380 may include a second portion 384 that may be adapted to display a second player profile, such as a player profile of the second player 110. The first portion 382 and the second portion 384 may present a comparative analysis of various performance parameters, such as “Shot-type”, “Pressure”, and “Speed”, related to the first player 108 and the second player 110, respectively.

In accordance with an embodiment, the processor 202 may be operable to receive a request from one of the one or more electronic devices 104, such as the first smartphone 118. The processor 202 may be operable to compare the player profile of the first player 108 with the player profile of the second player 110.

The one of the one or more electronic devices 104, such as the first smartphone 118, may be operable to display results of the comparison, via the UI 380. The comparison results may be displayed in parallel views. For example, a first view of a stroke trajectory of a top-spin shot of the first player 108 may be displayed as juxtaposed to a second view of a stroke trajectory of a top-spin shot of the second player 110. Such comparative analysis may be easy-to-understand and may aid in performance improvement of the first player 108 and/or the second player 110.

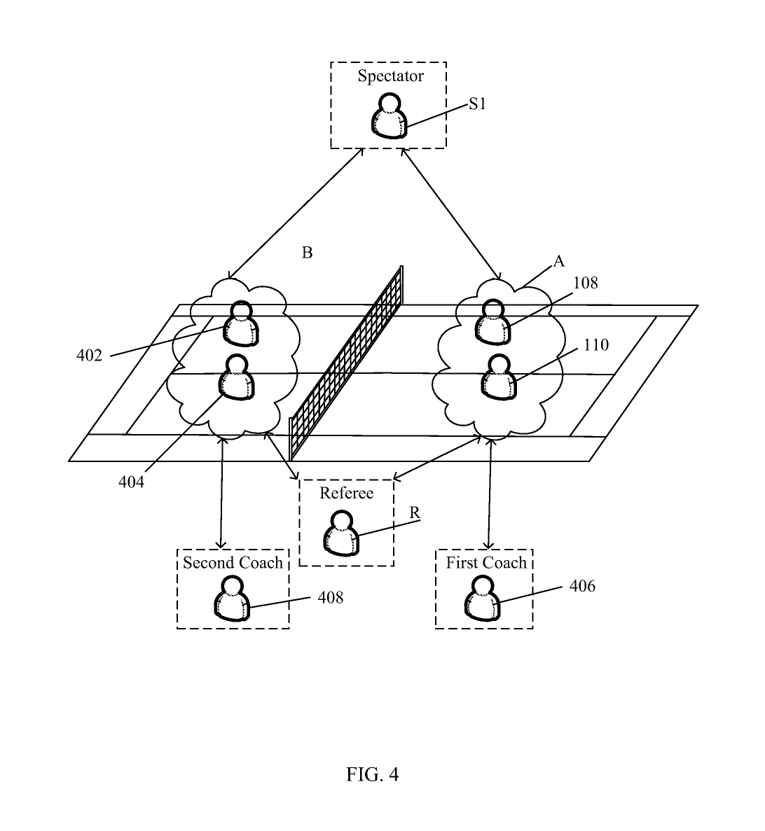

FIG. 4 illustrates a second exemplary scenario for implementation of the disclosed system and method to process information, in accordance with an embodiment of the disclosure. FIG. 4 is explained in conjunction with elements from FIGS. 1A, 2, 3A, 3B, 3C, 3D, 3E, and 3F. With reference to FIG. 4, there is shown the first player 108, the second player 110, a third player 402, a fourth player 404, a first coach 406, a second coach 408, the referee, “R”, and one or more spectators, such as the spectator, “S1”.

In accordance with the second exemplary scenario, the third player 402 and the fourth player 404 may correspond to the one or more players. The first coach 406 and the second coach 408 may correspond to the coach, “C1”. The first player 108 and the second player 110 may be in the first team, “A”. The third player 402 and the fourth player 404 may be in the second team, “B”. A portable device may be associated with each player, the first coach 406, the second coach 408, the referee “R”, and the one or more spectators, such as the spectator, “S1”. The one or more portable devices associated with each player, the first coach 406, the second coach 408, the referee “R”, and the spectator, “S1” are not shown for the sake of brevity.

In operation, the processor 202 may be operable to receive device metadata and information from multiple players, such as the first player 108, the second player 110, the third player 402, and the fourth player 404. Such receipt may be similar to the receipt of the device metadata and the player information as described in FIGS. 3A to 3E for a single player, such as the first player 108.

The processor 202 may be operable to establish a selective communication among the one or more electronic devices 104, in the communication network 106. Such selective communication may be established based on the received device metadata from the one or more electronic devices 104. The one or more electronic devices 104 may be associated with the first player 108, the second player 110, the third player 402, and the fourth player 404. The one or more electronic devices 104 may also comprise the portable devices of the first coach 406, the second coach 408, the referee, “R”, and the spectator, “S1”.

A first restricted sub-network may be created for the team, “A”. Similarly, a second restricted sub-network may be created for the team, “B”. A first portable device of the first coach 406 may be operable to feed instructions in the first restricted sub-network of the team, “A”. Similarly, a second portable device of the second coach 408 may be operable to feed instructions in the second restricted sub-network of the team, “B”. A third portable device of the referee, “R” may be operable to feed scores via a UI of the third portable device. The scores may be accessible to both the teams, such as the team, “A” and the team, “B”. A fourth portable device associated with the spectator, “S1”, may provide feedback information to both the first restricted sub-network and the second restricted sub-network.

In accordance with an embodiment, the first portable device of the first coach 406 may be operable to selectively access information related to the first player 108 and/or the second player 110. However, the first portable device of the first coach 406 may be restricted to access information related to the team, “B”. Similarly, the second portable device of the second coach 408 may be operable to selectively access information related to the third player 402 and/or the fourth player 404.

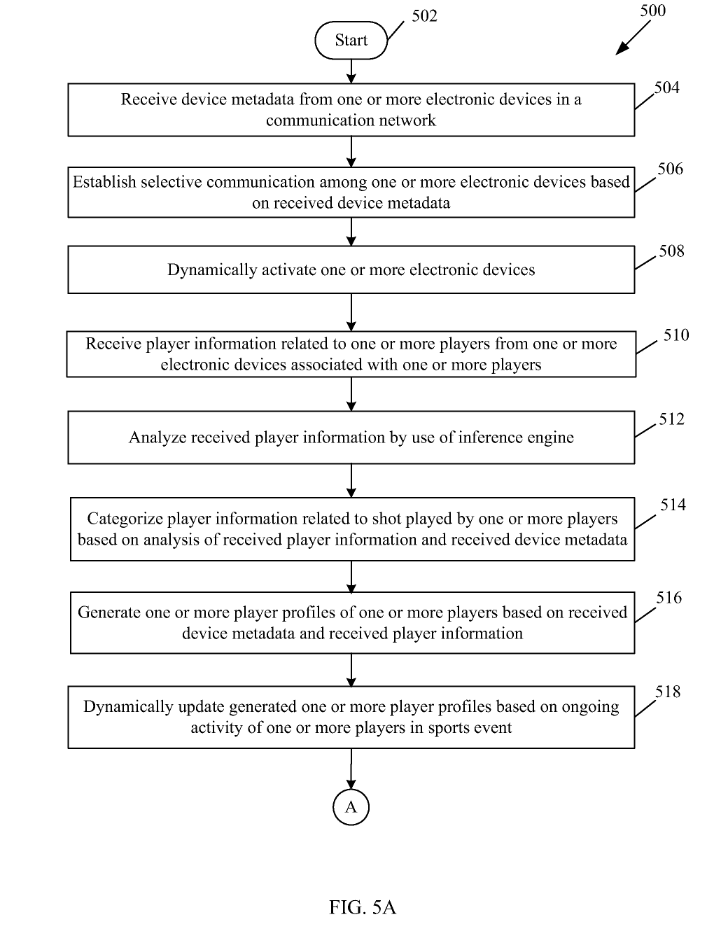

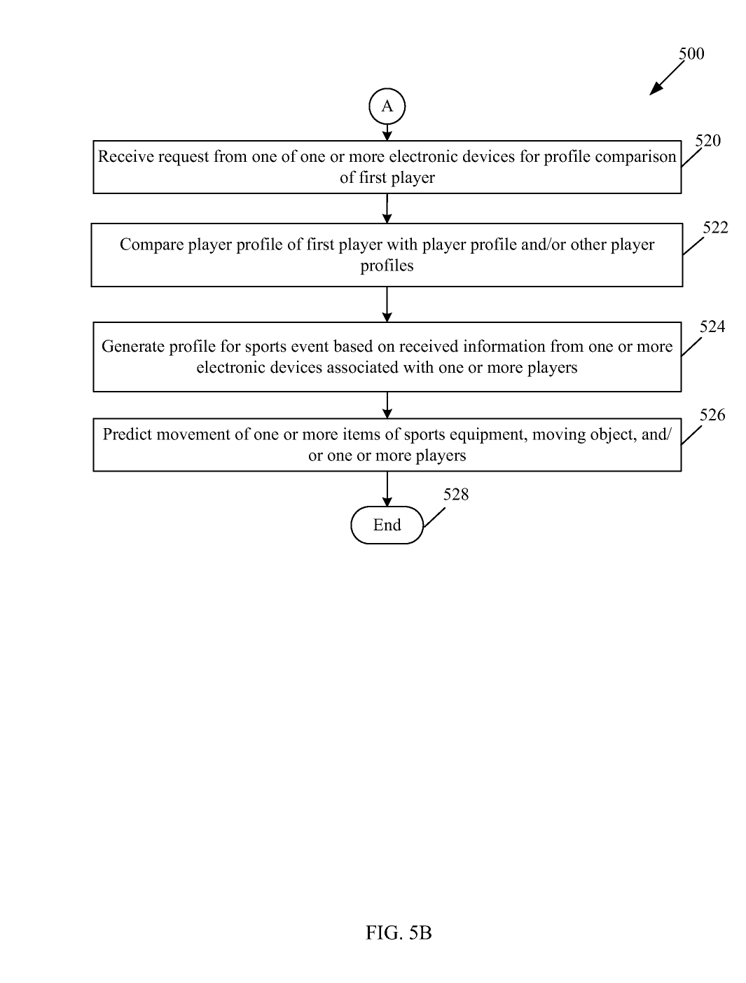

FIGS. 5A and 5B collectively represent a flow chart that illustrates an exemplary method to process information, in accordance with an embodiment of the disclosure. With reference to FIG. 5, there is shown a flow chart 500. The flow chart 500 is described in conjunction with FIGS. 1A and 2. The method starts at step 502 and proceeds to step 504.

At step 504, device metadata may be received from the one or more electronic devices 104 in the communication network 106. At step 506, selective communication may be established among the one or more electronic devices 104, based on the received device metadata. At step 508, the one or more electronic devices 104 may be dynamically activated to perform corresponding actions. For example, a video capturing device may capture photographs and a sensor may detect an event, physical or quantitative attributes. Such activation may occur based on a notification received from one of the one or more electronic devices 104 and/or occurrence of an event. At step 510, player information may be received from the one or more electronic devices 104, associated with the one or more players.

At step 512, the received player information may be analyzed by use of the inference engine unit 204. At step 514, information related to a shot played by one or more players, such as the first player 108, may be categorized based on an analysis of the received player information and the received device metadata. The received player information may be associated with a time period. The time period may include a timestamp when a moving object is in contact with an item of sports equipment held by the first player 108.

At step 516, one or more player profiles of the one or more players may be generated based on the received device metadata and the received player information. At step 518, the generated one or more player profiles may be dynamically updated based on ongoing activity of the one or more players in the sports event. At step 520, a request may be received from one of the one or more electronic devices 104, to compare the player profile of the first player 108 with other player profiles from the one or more player profiles.

At step 522, the generated player profile of the first player may be compared with the historical player profile of the first player 108 and/or generated player profiles of other players. At step 524, a sports event profile for the sports event may be generated based on the received player information from the one or more electronic devices 104, associated with the one or more players. At step 526, a movement of the one or more items of sports equipment, a moving object, and/or the one or more players may be predicted. The movement may correspond to a stroke trajectory of the item of sports equipment, a displacement trajectory of the moving object, and/or footwork of the one or more players. Control passes to end step 528.

In accordance with an embodiment of the disclosure, a system to process information is disclosed. The server 102 may comprise one or more circuits and/or processors (hereinafter referred to as the processor 202 (as shown in FIG. 2)). The processor 202 may be operable to receive device metadata from one or more electronic devices 104 (as shown in FIG. 1A) in the communication network 106. The processor 202 may be operable to receive player information from the one or more electronic devices 104 associated with the one or more players. The processor 202 may be further operable to generate a player profile of a first player 108, based on the received device metadata and the received information.

Various embodiments of the disclosure may provide a non-transitory computer readable medium and/or storage medium, and/or a non-transitory machine readable medium and/or storage medium having stored thereon, a machine code and/or a computer program with at least one code section executable by a machine and/or a computer to process information. The at least one code section in a server may cause the machine and/or computer to perform the steps that comprise receipt of device metadata from one or more electronic devices in a communication network. Player information may be received from the one or more electronic devices associated with the one or more players. A player profile of a first player may be generated based on the received device metadata and the received information.

The present disclosure may be realized in hardware, or a combination of hardware and software. The present disclosure may be realized in a centralized fashion, in at least one computer system, or in a distributed fashion, where different elements may be spread across several interconnected computer systems. A computer system or other apparatus adapted for carrying out the methods described herein may be suited. A combination of hardware and software may be a general-purpose computer system with a computer program that, when loaded and executed, may control the computer system such that it carries out the methods described herein. The present disclosure may be realized in hardware that comprises a portion of an integrated circuit that also performs other functions.

The present disclosure may also be embedded in a computer program product, which comprises all the features enabling the implementation of the methods described herein, and which when loaded in a computer system is able to carry out these methods. Computer program, in the present context, means any expression, in any language, code or notation, of a set of instructions intended to cause a system having an information processing capability to perform a particular function either directly, or after either or both of the following: a) conversion to another language, code or notation; b) reproduction in a different material form.

While the present disclosure has been described with reference to certain embodiments, it will be understood by those skilled in the art that various changes may be made and equivalents may be substituted without departing from the scope of the present disclosure. In addition, many modifications may be made to adapt a particular situation or material to the teachings of the present disclosure without departing from its scope. Therefore, it is intended that the present disclosure not be limited to the particular embodiment disclosed, but that the present disclosure will include all embodiments falling within the scope of the appended claims.

What is claimed is:

1. A system for processing information, the system comprising:
one or more circuits operable to:
receive device metadata and player information from one or more electronic devices in a communication network, wherein said one or more electronic devices are associated with one or more players; and
generate one or more player profiles of said one or more players based on said received device metadata and said received player information.

2. The system as claimed in claim 1, wherein said device metadata comprises one or more of: device identifiers of said one or more electronic devices, user-type data, device category data, and/or configuration data associated with each of said one or more electronic devices.

3. The system as claimed in claim 2, wherein said user-type data corresponds to a player, a spectator, a referee, and/or a coach.

4. The system as claimed in claim 2, wherein said device category data corresponds to a data provider and/or a controller.

5. The system as claimed in claim 1, wherein said player information corresponds to one or more of: stroke trajectory information of one or more items of sports equipment, shot-type information of said one or more items of sports equipment, contact information of a moving object with said one or more items of sports equipment, speed information of said moving object, trajectory information of said moving object, spin information of said moving object, footwork information of said one or more players, heart rate monitoring information of said one or more players, a video feed associated with said one or more players, feedback information associated with said one or more players, geospatial positioning information of said one or more players, and/or one or more notifications that indicate a new session of a sports event with respect to said receipt of said player information.

6. The system as claimed in claim 5, wherein said one or more items of sports equipment comprises one of: a racquet, a bat, and/or a stick.

7. The system as claimed in claim 5, wherein said moving object comprises one of:
a ball, shuttlecock, and/or a hockey puck, wherein said moving object is associated with said one or more items of sports equipment.

8. The system as claimed in claim 1, wherein said one or more electronic devices comprises one or more of: a sensor, a portable device, a radar, and/or a video capturing device.

9. The system as claimed in claim 1, wherein one of said one or more electronic devices is operable to create an ad-hoc network to establish communication with others of said one or more electronic devices, wherein said one of said one or more electronic devices is communicatively coupled to said one or more processors in said communication network.

10. The system as claimed in claim 1, wherein said one or more circuits are further operable to establish selective communication among said one or more electronic devices within said communication network based on said received device metadata.

11. The system as claimed in claim 1, wherein said one or more circuits are further operable to dynamically update said generated said one or more player profiles based on ongoing activity of said one or more players in a sports event.

12. The system as claimed in claim 1, wherein said one or more circuits are further operable to generate a profile for a sports event based on said received player information from said one or more electronic devices associated with said one or more players.

13. The system as claimed in claim 1, wherein said one or more circuits are further operable to categorize information related to a shot played by a player based on analysis of said received player information and said received device metadata, wherein said received player information is associated with a time period that includes a timestamp when a moving object is in contact with an item of sports equipment held by said player.

14. The system as claimed in claim 13, wherein said one or more circuits are further operable to compare a player profile from said generated one or more player profiles with other player profiles from said generated one or more player profiles.

15. The system as claimed in claim 14, wherein said one or more circuits are further operable to compare said player profile of a player with a historical player profile of said player.

16. The system as claimed in claim 1, wherein said one or more circuits are further operable to predict a movement of one or more items of sports equipment, a moving object, and/or said one or more players, wherein said movement corresponds to a stroke trajectory of said moving object, a trajectory of said moving object, and/or footwork of said one or more players.

17. The system as claimed in claim 1, wherein said one or more circuits are further operable to dynamically activate said one or more electronic devices to perform corresponding action based on a notification received from one of said one or more electronic devices and/or occurrence of an event.

18. A method for processing information, the method comprising:
in a server:
receiving device metadata and player information from one or more electronic devices in a communication network, wherein said one or more electronic devices are associated with one or more players; and
generating one or more player profiles of said one or more players based on said received device metadata and said received player information.

19. The method as claimed in claim 18, further comprising dynamically updating said generated player profile of said first player based on ongoing activity of said first player in a sports event.

20. The method as claimed in claim 18, further comprising categorizing information related to a shot played by a player based on analysis of said received player information and said received device metadata, wherein said received player information is associated with a time period that includes a timestamp when a moving object is in contact with an item of sports equipment held by said player.

21. The method as claimed in claim 18, further comprising establishing selective communication among said one or more electronic devices within said communication network based on said received device metadata.
